(19) United States
(12) Patent Application Publication
(10) Pub. No.: US 2009/0000132 A1
(43) Pub. Date: Jan. 1, 2009

(54) REDUCED VIBRATION SAW HANDLE

(75) Inventors: John Alexander, Sheffield (GB); Stewart Hawley, Sheffield (GB); Terence Jones, Chesterfield (GB); Stephen Rowlay, Sheffield (GB)

Correspondence Address: PILLSBURY WINTHROP SHAW PITTMAN, LLP, P.O. BOX 10500, MCLEAN, VA, 22102, US

(73) Assignee: THE STANLEY WORKS, New Britain, CT (US)

(21) Appl. No.: 11/771,844

(22) Filed: Jun. 29, 2007

(51) Int. Cl. B23D 51/01; B23D 57/00

(52) U.S. Cl. 30/517; 83/835

(57) ABSTRACT

A saw handle for reducing the amount of vibration transmitted to a user during use of a saw. The handle includes a resilient material of lower durometer than the blade mount and is interposed between the blade mount and the user's hand in order to absorb and reduce the vibrations transmitted to the user. In one configuration, the resilient material is interposed between the blade mount and the handle in order to isolate handle from the blade mount. In another configuration, the handgrip is of a resilient material devoid of an internal structure. In yet another configuration, the handgrip is of a resilient material with an internal structure, where the internal structure may have an overlapping or non-overlapping configuration.

### BACKGROUND OF THE INVENTION

The present invention relates to handgrips for hand tools, and more particularly, relates to vibration damping for reducing the degree of vibrations transmitted to a user's hand during operation of a saw.

### SUMMARY OF THE INVENTION

An object of the present invention is to provide a saw comprising: a saw blade; a blade mount connected to the blade; a handgrip; and a resilient vibration absorbing coupler that couples the blade mount with the handgrip.

According to another aspect of the present invention, there is provided a saw comprising: a saw blade; a blade mount connected to the blade, the blade mount comprising an upper coupling portion and a lower coupling portion; and a resilient handgrip having an upper region connected to the upper blade mount coupling portion and a lower region connected to the lower blade mount coupling portion, wherein the resilient handgrip is devoid of a rigid structure through at least one of its cross sections between the upper region and the lower region.

According to another aspect of the present invention, there is provided a saw comprising: a saw blade; a blade mount connected to the blade; a handgrip; and an elongated resilient structure formed from a resilient metal or plastic material extending into the handgrip and being joined with the blade mount, the elongated resilient structure enabling flexing of the handgrip during a sawing operation.

### BRIEF DESCRIPTION OF THE DRAWINGS

FIG. 1 is a side view of the handsaw, partly in cross-section, showing the handgrip vibration damper according to one embodiment.

FIG. 2 is a side view of the handsaw, partly in cross-section, showing the handgrip vibration damper according to another embodiment.

FIG. 3 is a side view of the handsaw, partly in cross-section, showing the handgrip vibration damper according to another embodiment.

FIG. 4 is a side view of the handsaw, partly in cross-section, showing the handgrip vibration damper according to another embodiment.

FIG. 5 is a side view of the handsaw, partly in cross-section, showing the handgrip vibration damper according to another embodiment.

FIG. 6 is a side view of the handsaw, partly in cross-section, showing the blade fastener vibration damper according to one embodiment.

FIG. 7 is a cross-sectional view taken through the line 7-7 in FIG. 6.

### DETAILED DESCRIPTION OF THE INVENTION

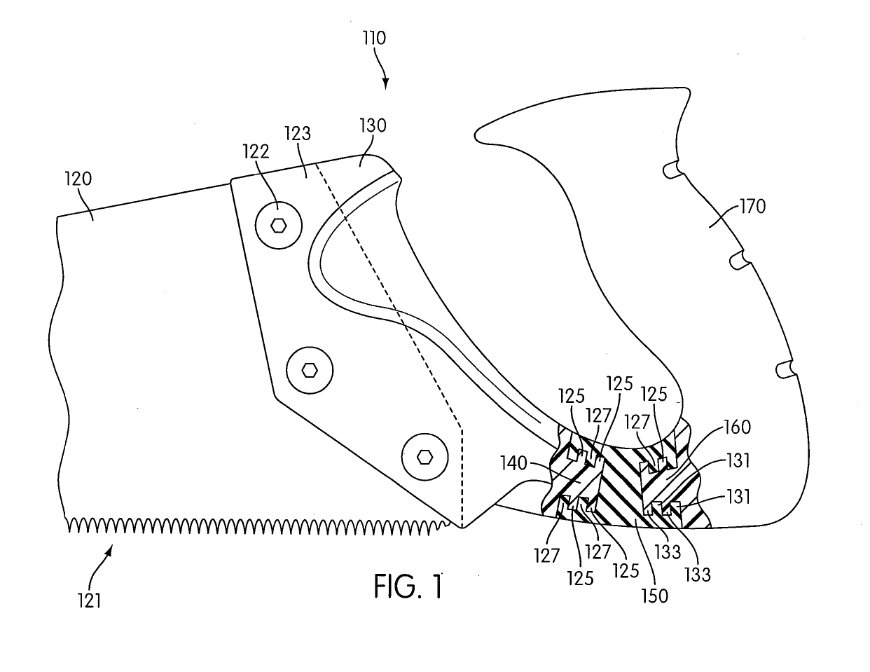

FIG. 1 illustrates a vibration damping handsaw 110 with a construction for reducing the degree of vibration transmitted to the hand of a user during sawing according to one embodiment of the present invention. The saw 110 has a metallic saw blade 120 with a toothed cutting edge 121 for cutting wood, metal, plastic, building materials, or other materials. The saw blade 120 is connected to a rigid blade mount 130, which is in turn operatively attached to a handgrip 170. The blade mount 130 may be composed of an inflexible material such as wood, metal, plastic, or fiberglass and has two opposing portions 123 that sandwich the blade 120 therebetween (only one of such portions being shown in FIG. 1 as will be appreciated by those skilled in the art).

The blade mount 130 is attached to the saw blade 120 by blade fasteners 122. In one embodiment, the fasteners 122 are attached to both of the two opposing blade mount portions 123. The portions 123 may be integrally formed with one another, leaving a space therebetween for receiving the blade 120. In another embodiment, the portions 123 may be formed of two separate structures secured together, e.g. by the fasteners 122 which pass through holes or openings in the proximal regions of the blade 120.

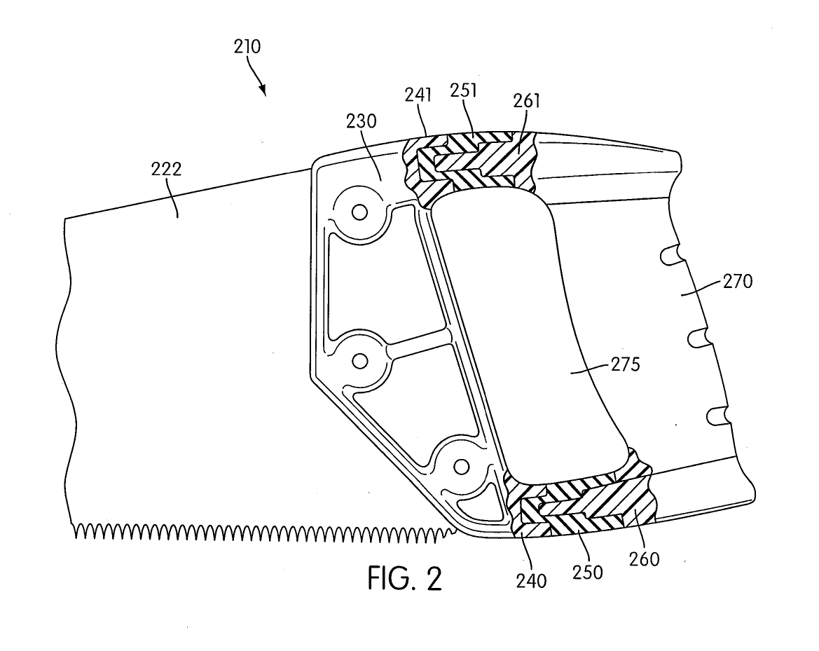

Blade fasteners 122 may be any fastener that connects the saw blade 120 to the blade mount 130. For example, the fasteners 122 may be screws, bolts, or rivets. The blade fasteners 122 may provide a permanent connection between the handle mount 130 and saw blade 120. In other embodiments, the blade fasteners 122 may be removable by the user in order to facilitate changing of the saw blade 120 by the user. The use of blade fasteners described above for connecting the saw blade to a blade mount is but one mechanism for connecting the saw blade, and it should be appreciated that other known methodologies and mechanisms can be used. It should also be appreciated that the blade fasteners described above, or the other know methodologies and mechanisms can also be used in the embodiments of FIGS. 2-6, and thus will not be repeated below with respect to the descriptions of those embodiments.

The blade mount 130 is coupled to the handgrip 170 by a resilient vibration absorber or damper 150. Specifically, the blade mount 130 has a coupling portion 140, while the handgrip 170 has a coupling portion 160. In one embodiment, blade mount 130, blade mount coupling portion 140, handgrip 170, and handgrip coupling portion 160 are each composed of a material that has a higher durometer than the resilient vibration absorbing portion 150. The vibration absorbing portion may be formed from rubber, a rubber based material, elastomeric material, or other elastic materials. In another embodiment, a resilient metal formed into a spring configuration may be used. In another embodiment, any combination of these materials can be used. For example, a metallic spring that is coated or engulfed in a rubber, rubber based, or other elastic material may be used. The blade mount 130, blade mount coupling portion 140, handgrip 170, and blade mount coupling portion 160 may be composed of the same material (which material may be, for example, wood, plastic, elastomer, metal or rubber), or alternatively, may be composed of different materials in order to best match the part's requirement for rigidity, strength, comfort, and manufacturability with the part's material.

The coupling portions 140 and 160 may be connected to the vibration damping portion 150 by a mechanically interlocking configuration, adhesive, vulcanization, ultrasonic welding, or other method of attachment. The coupling portions 140 and 160 are designed to provide a high strength connection between the coupling portions and the vibration absorbing portion 150.

In one embodiment of the invention, the coupling portions 140 and 160 have a plurality of alternating protrusions 125 and recesses 127 that extend into resilient vibration absorbing portion 150. Similarly, the vibration absorbing portion 150 has a plurality of protrusions 131 that are received in recesses 127, and recess 133 that receive the protrusions 125. The interlocking configuration may be of any design that interlocks the coupling portions 140 and 160 with the resilient vibration absorbing portion 150. The interlocking of the coupling portions 140 and 160 and the vibration absorbing portion 150 helps to resist the force during sawing that could otherwise separate the blade mount 130 and the handgrip 170 from the resilient vibration absorbing portion 150. In addition, in other embodiments of the invention, the coupling portions 140 and 160 are joined to the vibration absorbing portion 150 by adhesive, vulcanization, or ultrasonic welding, for example. As shown, a hand receiving region 175 is disposed between handgrip 170 and blade mount 130.

FIG. 2 illustrates a vibration damping handsaw 210 according to another embodiment of the present invention. In this embodiment, rigid blade mount 230 is connected to the handgrip 270 by a pair of resilient, vibration absorbing coupling portions 250 and 251. Specifically, the blade mount 230 has a pair of blade mount coupling portions 240 and 241, and the handgrip has a pair of handgrip coupling portions 260 and 261. A first connection between the blade mount and the handgrip includes the first blade mount coupling portion 240, the first vibration absorbing coupling portion 250, and the first handgrip coupling portion 260 located at a lower side of the handgrip. A second connection includes the second blade mount coupling portion 241, the second vibration absorbing portion 251, and the second handgrip coupling portion 261 located at an upper side of the handgrip. The handgrip 270 and the blade mount 230 define a hand receiving opening 275 therebetween. In contrast with the embodiment of FIG. 1, the opening 275 is bounded on all sides by the handgrip 270, blade mount 230, and coupling portions 250 and 251 as shown.

The second (upper) handgrip connection at resilient coupling 251 provides additional reinforcement (in comparison with the embodiments of FIG. 1) between the blade mount 230 and the handgrip 270, thus reducing the amount of torque subjected to the first vibration damping portion 250 and the relative amount of flex between blade mount 230 and handgrip 270. In addition, the second handgrip connection provides additional surface area in the connection between blade mount 230 and the handgrip 270. As a result, stresses are reduced at the vibration damping portions 250 and 251. In the embodiment of FIG. 2, the vibration damping material could have a lower durometer to increase its ability to damp vibration while still maintaining the saw's ruggedness.

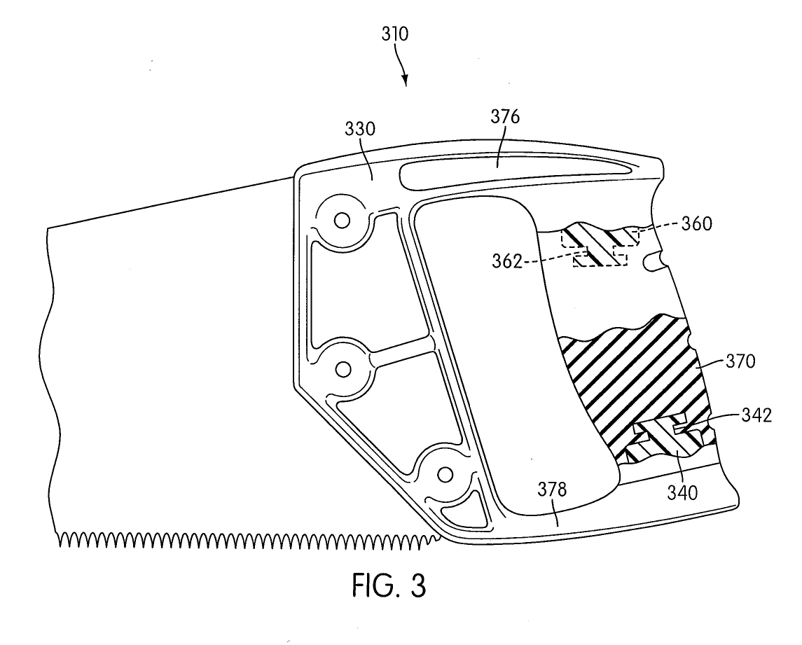

The blade mount coupling portions 240 and 241 are configured so that the at least one structure of the handgrip coupling portions 260 and 261 overlaps and meshes with the plurality of blade mount coupling structures 240 and 241, as shown in FIG. 2. The coupling portions 240, 241, 260, and 261 have a generally nesting configuration, but provide a gap between blade mount coupling portion 240 and handgrip coupling portion 260, and also between blade mount coupling portion 241 and handgrip coupling portion 261. A resilient material is provided in the gap between the coupling portions and forms vibration damping portions 250 and 251, which are capable of isolating and reducing the magnitude of vibrations transmitted to the handgrip from the saw blade. The resilient material forming vibration damping portions 250 can be of any of the types disclosed above with respect to the first embodiment, and this is true for the additional embodiments illustrated in FIGS. 3-6 as well.

FIG. 3 illustrates another embodiment of the present invention. According to one aspect of the embodiment, a saw 310 includes a resilient handgrip 370 connected between a rigid first coupling portion 340 fixed to, or integrally formed or molded with, a lower portion of blade mount 330 and a rigid second coupling portion 360 fixed to, or integrally formed or molded with, an upper portion of blade mount 330. Elongated connecting portion 376 forms an upper extension of the blade mount 330 and joins with coupling portion 360, while connecting portion 378 forms a lower extension of the blade mount 330 and joins with coupling portion 340. It should be appreciated that any of these structures can be integrally molded, or formed separately and subsequently connected to one another. In one embodiment, the resilient handgrip 370 comprises a resilient material having a durometer lower than that of the blade mount. The resilient handgrip 470 is devoid of a rigid structure between the coupling portions 340 and 360 as can be appreciated from FIG. 3. The handgrip 370 may consist of a single material (e.g., elastomeric or rubber based); or may comprise an outer resilient (e.g., elastomeric or rubber based) protective layer surrounding an inner resilient material (e.g., elastomeric or rubber based). In the case of inner and outer layers, the outer layer may be of a higher durometer than the inner layer, or vice versa. The handgrip material is capable of flexing slightly and provides good vibration damping characteristics.

The rigid coupling portions 340 and 360 are configured to project into and interlock with the resilient material of resilient handgrip 370. For example, the coupling portions 340 and 360 have respective grooves 342 and 362 for receiving a portion of the resilient material of handgrip 370. The coupling portions 340 and 360 may, in some embodiments, be configured without an interlocking arrangement with the resilient material, however, interlocking the resilient handgrip with the coupling portions increases the strength of the mechanical connection between the handgrip 370 and blade mount 330. The coupling portions 340 and 360 may be configured in a variety of interlocking arrangements in order to increase the strength of the connection. The interlocking configuration also increases the surface area between the resilient material and the coupling portions. As a result, if the coupling portions and the resilient material are joined by vulcanization, ultrasonic welding, or by adhesive, for example, the strength of the connection is increased.

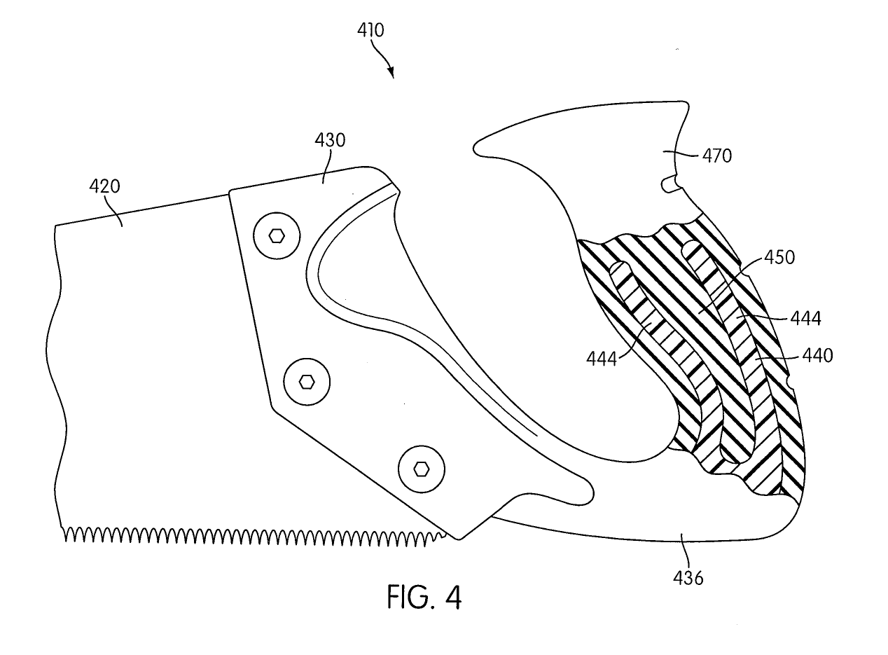

FIG. 4 illustrates a vibration damping handsaw 410 according to another embodiment of the present invention. In this embodiment, rigid blade mount 430 comprises a rigid lower longitudinal extension 436 and an upwardly extending coupling portion 440 that extends into the handgrip 470. The handgrip 470 comprises a vibration absorbing portion 450 that surrounds the coupling portion 440.

The blade mount coupling portion 440 comprises a plurality of elongated, spaced structures 444, extending upwardly from the lower extension 436 to form a generally elongated “U” configuration. The elongated structures 444 are configured to project into the vibration damping portion 450 formed by the resilient material of handgrip 470. In FIG. 4, a blade mount 430 having two such structures 444 is illustrated, although it is possible for the coupling portion 440 to have only a single structure 444 or three or more of such structures. In one embodiment, the elongated structures 444 are formed from a resilient plastic, a resilient metal material, or other resilient material constructed and arranged to undergo a slight flexing movement during a sawing operation. This bending or flexing action is enabled by the size (e.g., thickness, length) and type of material, and it returns to its originally formed configuration when force applied thereto is released. The elongated structures, therefore, act as resilient springs to further dampen vibration. The resilient structures 444 may be integrally formed with, or be considered part of the blade mount 430. Alternatively, the resilient structures 444 may be formed (e.g., molded) separately from the blade mount 430 and connected thereto in any conventional manner. The resilient structures 444 may be considered to be part of the blade mount 430 or part of the handgrip 470. In one embodiment, the blade mount 430 and handgrip 470 may be formed in a multi-shot injection molding process. For example, blade mount 430, comprising the blade mount coupling portion 440, may be molded with a material (such as plastic) having a higher durometer in a first shot; and the handgrip 470, comprising the vibration absorbing portion 450, may be over-molded the coupling portion 440 in a second shot. Such a process may optionally be used in each of the embodiments described herein. Alternatively, in any of the embodiments, the blade mount, and optionally (in some embodiments) a handgrip, may be formed separately, placed into a mold, and a single shot of resilient material can be injected into a mold and formed around the associated coupling portions.

Vibrations produced at saw blade 420 and transmitted though blade mount 430 will be damped by the resilient material 450 of the handgrip 470, thus lessening or eliminating any vibration transmitted to the user.

In other embodiments, similar to FIGS. 1 and 4, but not illustrated herein, the saw handle may be provided with a lower opening for receiving the user's hand rather than the illustrated upper opening.

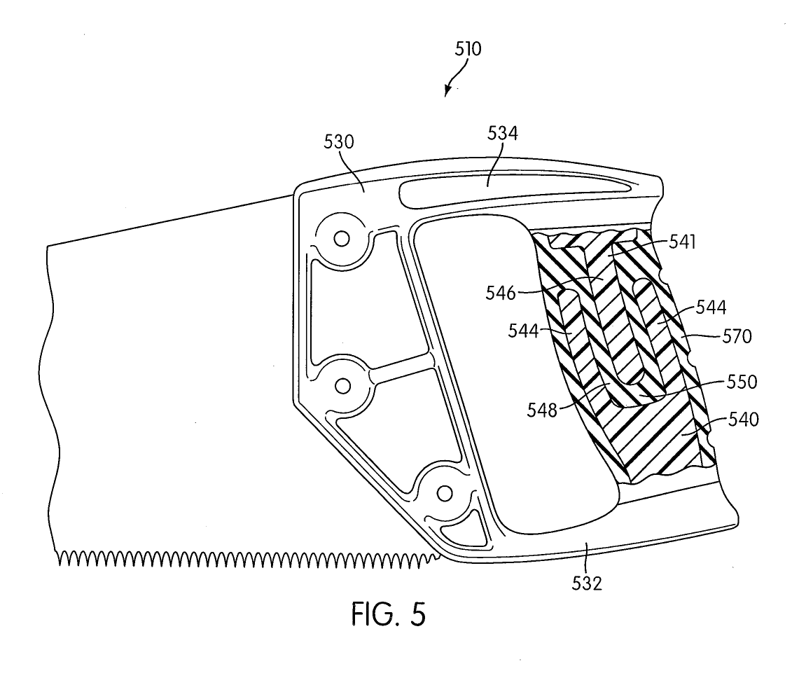

FIG. 5 illustrates a vibration damping handsaw 510 according to another embodiment of the present invention. In this embodiment, blade mount 530 comprises a first blade mount coupling portion 540 extending upwardly from a lower extension 532 of the blade mount 430, a second blade mount coupling portion 541 extending downwardly from an upper extension 534 of the blade mount 530, and a vibration absorbing portion 550 disposed therebetween forming the handgrip 570.

The first and second blade mount coupling portions 540 and 541 comprise a plurality of structures that project into the damping portion 550. For example, FIG. 5 illustrates a first blade mount coupling portion 540 having two spaced, elongated structures 544, although it is possible for the coupling portion to have a greater number of such structures. In addition, FIG. 5 illustrates the second blade mount coupling portion 541 having one such structure 546, although it is recognized that the coupling portion may be configured to have a greater number of such structures.

The first coupling portion 540 and the second coupling portion 541 are configured such that the at least one structure of coupling portion 541 overlaps and meshes with the plurality of structures of coupling portion 540. Specifically, the elongated structure 546 extends in between the spaced, elongated structures 544 as shown. A “U” shaped gap 548 formed between the structures 544 and 546 is filled with the vibration damping material 550, which is capable of isolating and reducing the magnitude of vibrations transmitted to the handgrip from the saw blade. The resilient material 550 also entirely engulfs the coupling portions 540 and 541 to provide the handgrip 570 with a resilient outer grip surface. The resilient, vibration damping coupling material described in each of the embodiments may also be used to form a resilient outer surface for the associated handgrips. For some embodiments, such as in FIGS. 1 and 2, this can be accomplished simply by increasing the amount of resilient material, and by modifying the injection mold so that the resilient material forming the resilient vibration damping coupling also flows in surrounding relation to the handgrip portion.

Similarly to the resilient structures 444 in the embodiment of FIG. 4, the structures 544 and 546 may be formed from a resilient material that allows flexing thereof to facilitate damping of vibration. In other embodiments, zero, one, or more than two resilient structures 544 may be provided. Similarly, zero, two, or more structures 546 may be provided. Any combination of the number of resilient structures 544, 546 is contemplated.

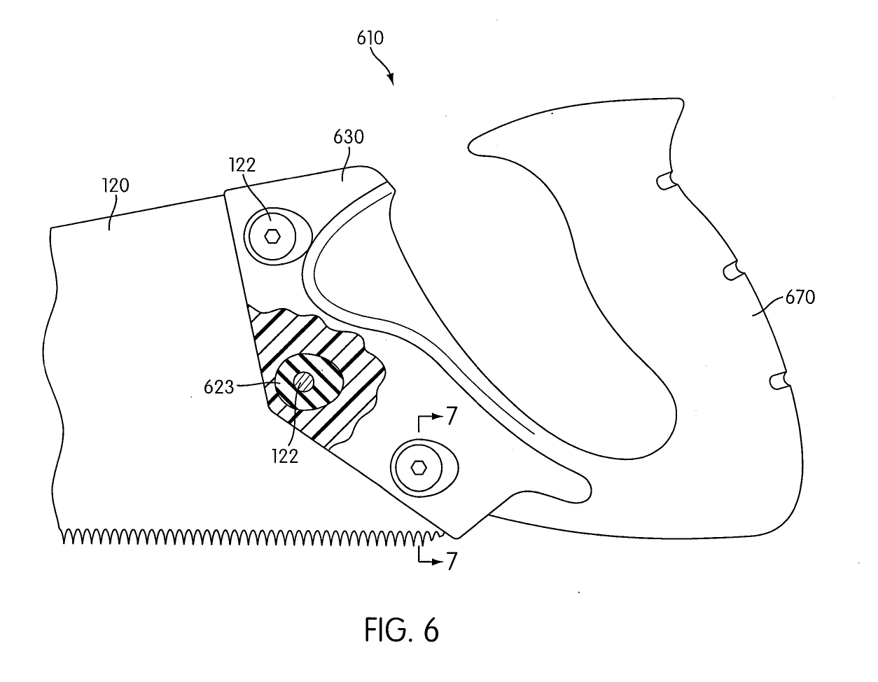

FIG. 6 illustrates blade fastener vibration damping according to an embodiment of the present invention. In this embodiment, the saw 610 comprises a blade mount 630 and a handgrip 670. A resilient material 623 is interposed between the blade mount fasteners 122 (as described above) and the blade mount 630. For example, the resilient material 623 may be interposed between the fastener 122 and the blade mount 630 such that the fastener 122 and blade mount 630 are not in direct contact. The shape of the resilient portion 623 may be cylindrical or circular. Alternatively, the resilient portion 623 may have an elongated shape in order to provide a greater amount of resilient material in the direction of greatest vibration. For example, FIG. 6 illustrates an oblong resilient portion 623 with a major axis extending in a horizontal direction that is generally parallel to the force applied by the user during sawing. The resilient portion 623 allows slight relative movement between the fasteners 122 and the blade mount 630. While the fasteners 122 may be rigidly connected to, or in direct contact with, the blade 120 so that no relative movement therebetween take place, it is also possible for the resilient material 623 to be disposed between the fasteners 122 and blade 120. In any case, the resilient material allows for slight relative movement between the blade 120 and the blade mount 630.

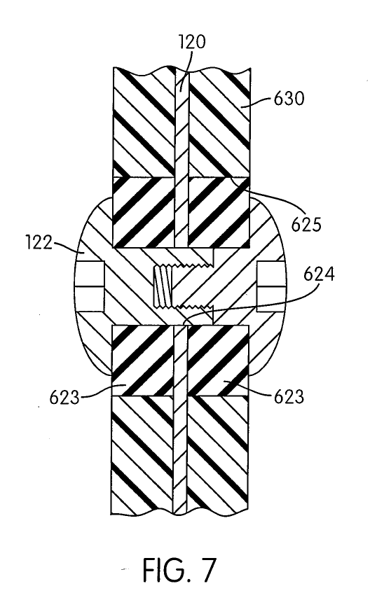

FIG. 7 illustrates a cross-section of the blade fastener vibration damper according to one embodiment. Fastener 122 extends through an opening 624 in saw blade 120 and an opening 625 in the blade mount 630. In one embodiment, the heads of fastener 122 do not contact the blade mount 630 as shown. Fastener 122, as shown, is removable in one embodiment to enable replacement of the saw blade. For example, fastener 122 may have a threaded screw connection with a male part and a female part, as shown. It is contemplated that any type of fastener arrangement can be used. For example, a riveted connection is also contemplated.

The resilient material 623 in this embodiment may comprise a pair of annular grommets 623, one on each side of the saw blade 120. The grommet 623 may be interposed between the fastener 122 and the blade mount 630 such that a sawing action causes compression of the resilient material 623 and permits slight relative movement between the blade 120 and blade mount 630. The resilient material dampens vibrations from the blade 120 that might be transmitted to blade mount 630.

It should be appreciated that the embodiments of FIGS. 6 and 7 can be used in conjunction or in combination with each of the embodiments of FIGS. 1-5.

While particular embodiments of the invention have been described, it is to be understood that modifications will be apparent to those skilled in the art without departing from the spirit of the invention. The scope of the invention is not limited to the specific embodiments described herein. Other embodiments, uses and advantages of the invention will be apparent to those skilled in art from consideration of the specification and practice of the invention disclosed herein. The specification should be considered as exemplary only, and the scope of the invention is accordingly intended to be limited only by the following claims.

We claim:

1. A saw comprising:
a saw blade;
a blade mount connected to the blade;
a handgrip; and
a resilient vibration absorbing coupler that couples the blade mount with the handgrip.

2. The saw of claim 1, wherein the vibration absorbing coupler couples a lower portion of the blade mount to a lower portion of the handgrip.

3. The saw of claim 2, further comprising an upper vibration absorbing coupler that couples an upper portion of the blade mount to an upper portion of the handgrip.

4. The saw of claim 2, wherein the handgrip comprises a handgrip coupling portion, the blade mount comprises a blade mount coupling portion, and wherein the vibration absorbing coupler couples the handgrip coupling portion with the blade mount coupling portion.

5. The saw of claim 3, wherein the handgrip comprises upper and lower handgrip coupling portions, the blade mount comprises upper and lower blade mount coupling portions, the vibration absorbing coupler couples the lower handgrip coupling portion with the lower blade mount coupling portion, and the upper vibration absorbing coupler couples the upper handgrip coupling portion with the upper blade mount coupling portion.

6. The blade mount of claim 1, further comprising:
a blade fastener for connecting the blade to the blade mount; and
a blade fastener vibration damper interposed between the blade fastener and the blade mount.

7. The saw of claim 1, wherein the resilient vibration absorbing couple comprises rubber or a rubber based material.

8. A saw comprising:
a saw blade;
a blade mount connected to the blade, the blade mount comprising an upper coupling portion and a lower coupling portion; and
a resilient handgrip having an upper region connected to the upper blade mount coupling portion and a lower region connected to the lower blade mount coupling portion, wherein the resilient handgrip is devoid of a rigid structure through at least one of its cross sections between the upper region and the lower region.

9. The saw of claim 8, wherein the handgrip comprises rubber or a rubber based material.

10. The blade mount of claim 8, further comprising:
a blade fastener for connecting the blade to the blade mount; and
a blade fastener vibration damper interposed between the blade fastener and the blade mount.

11. A saw comprising:
a saw blade;
a blade mount connected to the blade;
a handgrip; and
an elongated resilient structure formed from a resilient metal or plastic material extending into the handgrip and being joined with the blade mount, the elongated resilient structure enabling flexing of the handgrip during a sawing operation.

12. The saw of claim 11, wherein the handgrip comprises an elastomeric material surrounding the elongated resilient structure.

13. The saw of claim 11, wherein the elongated resilient structure is integrally joined with the blade mount.

14. The saw of claim 11, wherein the elongated resilient structure is formed separately from the blade mount and joined to the blade mount via a connection.

15. The saw of claim 11, further comprising a second elongated resilient structure, wherein the two elongated resilient structures extend generally in the same direction alongside one another and defining a region therebetween filled with an elastomeric material.

16. The saw of claim 11, wherein the elongated resilient structure extends generally upwardly from the region in which it is joined with the blade mount.

17. The saw of claim 11, further comprising a second elongated resilient structure, wherein the two elongated resilient structures extend in opposite directions to one another.

18. The saw of claim 17, further comprising a third elongated resilient structure, wherein two of the elongated resilient structures extend in generally the same direction and the third elongated resilient structure extends in an opposite direction and between the opposing two elongated resilient structures.
